(19) United States
(12) Patent Application Publication
(10) Pub. No.: US 2023/0118957 A1
(43) Pub. Date: Apr. 20, 2023

(54) SUPPORTING ARRANGEMENT FOR A PATIENT IN A PRONE POSITION

(71) Applicant: PRO MEDICARE S.R.L., MESAGNE (BR) (IT)

(72) Inventors: Rosaria Eugenia CAFORIO, MESAGNE (BR) (IT); Franco CARIOLO, MESAGNE (BR) (IT)

(21) Appl. No.: 17/914,477

(22) PCT Filed: Apr. 7, 2021
(86) PCT No.: PCT/IB2021/052883

§ 371 Date: Sep. 26, 2022

(30) Foreign Application Priority Data
Apr. 8, 2020 (IT) 102020000007522

(51) Int. Cl. A61G 13/12

(52) U.S. Cl. CPC A61G 13/1285; A61G 13/1205; A61G 13/1295; A61G 2200/325; A61G 2205/20

(57) ABSTRACT

A supporting system is provided for a patient in a prone position, especially for patients that are intubated and/or mechanically ventilated. The supporting arrangement ensures proper posture of the patient so as to prevent damages caused by prolonged lying in the prone position. The arrangement includes a kit of separate modules (10 - 40, 50sx, 50dx - 90sx, 90dx) for containing, pushing, supporting, and unloading distinct body segments of the patient’s body. The modules are freely positionable and orientable with respect to one another on an external supporting surface, such as a mattress. The supporting arrangement provides for a sub-arrangement intended for supporting the patient’s head and comprises modules for the head (10 -40) which make it possible to effectively support the user’s head in a neutral position as well as in a position turned to the side.

### TECHNICAL FIELD

The present invention relates to a supporting arrangement for a patient in a prone position.

More specifically, the present invention relates to a modular adaptable supporting arrangement for supporting one or more body segments of the body of a patient in a prone position.

The arrangement according to the invention makes it possible to optimize the postural distribution, unloading and alignment of a patient in a prone position.

### BACKGROUND ART

It is known that patients suffering from “Respiratory Distress Syndrome” and hospitalized in intensive care units may be intubated and/or mechanically ventilated over a long time.

During mechanical ventilation, those lung areas that are not under stress and those lung areas that are under stress react differently; in particular, the non-stressed areas are easily expandable and are often hyperventilated, whereas the stressed areas are not easily expandable and are often hypoventilated.

When the patient is in a prone position, the lung tissue close to the chest is non-stressed, and is therefore easily expandable and subject to hyperventilation, whereas the lung tissue close to the back is stressed, and is therefore hardly expandable and subject to atelectasis. On the contrary, when the patient is in a prone position, stressed areas and non-stressed areas are inverted, whereby the lung tissue close to the chest is stressed, whereas the lung tissue close to the back is no longer stressed.

Thus, it is advantageous to cyclically alternate periods of mechanical ventilation in a supine position with cycles of mechanical ventilation in a prone position, in such a way as to reach a balance: in the areas that are hyperventilated in the supine position, a reduction in the ventilation of the lung tissue is obtained once the patient is in the prone position, whereas in the areas that are hypovnetilated in the supine position, an increase in the ventilation of the lung tissue is obtained once the patient is in the prone position, and vice versa.

However, this cyclical alternation means that the patient has to remain in a prone position for long periods of many hours.

Though lying in a prone position for a long time brings great benefit to the patient’s lungs, at the same time it causes not only considerable discomfort to the patient, but also serious damage and collateral consequences due mainly to pressure, such as pressure ulcers, facial and body trauma, oedema, venous stasis, and so on.

The body parts that are most susceptible to such collateral damages caused by pressure are the abdomen, the breast (in female patients) and especially the face.

Joint, tendon and muscle damage due to prolonged lying in a prone position should also not be underestimated. This can affect the patients’ shoulders, hips and knees in particular.

In order to alleviate the aforementioned side effects, in particular those related to pressure, it has been proposed to use mattresses with one or more holes in the areas most susceptible to this damage.

In order to alleviate the aforementioned side effects, in particular those related to pressure, it has been proposed to use mattresses with one or more holes in the areas most susceptible to this damage. For example, document CN207590891U describes a mattress provided with a hole in the region intended for the patient’s face, whereas document CN204233341U describes a mattress provided with a first hole in the region intended for the patient’s face and a second hole in the region intended for the patient’s abdomen.

These solutions are clearly unsatisfactory for several reasons.

Firstly, they are in no way adaptable to the specific morphology of an individual patient, and therefore do not take into account that patients may be adults or children, and that they may have significantly different builds. Secondly, they affect a limited number of body segments of the patient.

Documents US 2010/0192300, WO 00/62731, WO 2006/110671 and WO 2011/062713 also disclose operating room beds or tables equipped with supports to support a patient in a prone position.

However, in this case as well, the adaptability of the position and orientation of these supports to the specific morphology of the patient is limited in that these supports are connected or constrained to the frame structure of the operating room bed or table.

As an alternative to the above-mentioned solutions, the use of inflatable supports for the head and body of the patient has been proposed. By way of example, document CN201379736Y illustrates a device comprising a first inflatable horseshoe-shaped element for the head of the patient and a second inflatable horseshoe-shaped element for the shoulders of the patient, said elements being linked to each other.

However, it is clear that this solution entails the same limitations as those mentioned above.

Document CN109498317A discloses a modular supporting arrangement comprising a left lower base module, a right lower base module, a left upper base module and a right upper base module. Said base modules are shaped in such a way that, once they are brought close to one another, they form a concavity capable of containing the patient’s abdomen. The described supporting arrangement further includes a separate module for supporting the patient’s forehead. Thanks to the modular design, the relative position of the base modules and the forehead module can be adjusted to account for the patient’s build.

Although the modular structure of the last-mentioned solution provides a certain degree of freedom in adapting the configuration to the patient’s build, in this case as well, the limitations are obvious.

Firstly, this solution, too, essentially only considers the patient’s abdomen, neglecting other equally important body segments.

Secondly, the limited number of modules places a stringent constraint on the ability to effectively tailor the modular structure to the specific morphology of the individual patient.

Thirdly, and much more importantly, the forehead module is completely insufficient for proper support of the head of the patient.

In particular, this solution - as well as those previously mentioned - is totally inadequate to properly support the head of the patient in a plurality of different positions.

WO 2007/146059 also suggests using inflatable supports for the patient’s body.

However, even in this case the adaptability of the position and orientation of these supports to the specific morphology of the patient is limited by the fact that these supports are connected or constrained to a base frame.

An object of the present invention is to overcome the limitations of the known art by providing an arrangement for supporting a patient in a prone position that is customizable and adaptable to the specific morphology of the individual patient.

Another object of the invention is to provide an arrangement for supporting a patient in a prone position that allows to account for a plurality of body segments of the patient, in order to alleviate any side effects related to prolonged lying in a prone position.

A further and not less important object of the present invention is to provide an arrangement for supporting a patient in a prone position that allows to correctly support the head of the patient in a number of different positions.

These and other objects are achieved by the supporting arrangement as claimed in the appended claims.

### SUMMARY OF INVENTION

The invention is based on the fact that, in order to ensure proper posture of a patient in a prone position, which posture can alleviate the patient’s discomfort and prevent collateral damage related to a prolonged lying in this position, it is necessary to obtain a customized arrangement for postural distribution, unloading and alignment of the whole body system of the patient, which arrangement should take into account the patient’s specific morphology.

This result cannot be obtained by using a single complete supporting surface, such as a mattress.

It can instead be obtained by means of a kit of separate modules for containing, pushing, supporting and unloading distinct body segments of the patient’s body.

Said modules do not form a supporting surface for the patient, but they cooperate with an external supporting surface (for example, a mattress) to obtain harmonic support for the patient’s musculoskeletal system.

However, said modules are entirely separate from said external supporting system and can be removably connected thereto. Thus, the position of each module can be freely selected and is in no way bound by the shape or structure of said external supporting surface.

In this respect it should be noted that, in the light of the above, the supporting arrangement according to the invention remarkably differs from the known solutions, such as those illustrated in documents US 2010/0192300, WO 00/62731, WO 2006/110671, WO 2011/062713 or WO 2007/146059.

In the aforesaid documents, the supports are constrained to a rigid base structure, such as the frame of an operating room bed or table, which limits the possibility of changing the position and orientation of each support. As a result, the possibility of adapting the support to the specific morphology of each individual is somehow hindered.

On the contrary, according to the invention, as the supporting arrangement does not comprise any base structure such as a mattress, a bed, an operating room table or the like, each module can be freely positioned and oriented with respect to the patient’s body, whereby the supporting system as a whole is perfectly adaptable to the specific morphology of each individual.

The supporting arrangement according to the invention thus consists of a kit of modules, wherein for one or more segments of the patient’s body there are provided one or more modules for containing, pushing, supporting and unloading said body segment, said modules being freely positionable and orientable with respect to one another.

Preferably, for each body segment there are provided one or more pairs of modules, the modules of each pair of modules being adapted to be arranged on the opposite sides of the patient’s body.

The body segments to be supported by the supporting arrangement according to the invention preferably include the area of the shoulders and clavicles, the area of the abdomen, the area of the hips, the area of the knees, the area of the shins and feet, and the area of the elbows.

Advantageously, the supporting arrangement according to the invention makes it possible to alleviate the pressure in the lungs and the diaphragm, improving oxygenation and breathing and the effects of pronation.

In addition, it makes it possible to facilitate work of the patient’s agonist and antagonist muscles, preventing tendon retractions and/or tensions and related damage to the joints.

The supporting arrangement according to the invention further provides for modules for the user’s head, which modules are worth separate discussion.

Properly ensuring the containing, pushing, supporting and unloading of the head of a patient lying in a prone position is extremely difficult. In particular, it is very difficult to obtain this result while allowing at the same time the possibility of orienting the patient’s head in different positions (for example, downwards, or turned to the side).

The supporting arrangement according to the invention achieves this result by providing a plurality of modules for the head that are different and separate and thus freely positionable and orientable with respect to one another.

Said modules for the head are shaped so that, once they are brought close to one another, their top surfaces form together a helix profile.

Advantageously, thanks to this measure, it is possible to obtain perfect adaptation and support for any head morphology and any position the head may take, avoiding pressure load points and preventing oedema formation.

### BRIEF DESCRIPTION OF DRAWINGS

Further features and advantages of the invention will become apparent from the following detailed description of a preferred embodiment thereof, which are given by way of non-limiting example with reference to the annexed drawings, in which:

FIG. 1 is a perspective view of a supporting arrangement according to a preferred embodiment of the invention;

FIG. 2 shows a patient lying in a prone position on the supporting arrangement of FIG. 1;

FIG. 3 is a perspective view of a detail of the supporting arrangement of FIG. 1 relating to the modules for the head of a patient;

FIG. 4a shows a patient’s head on the modules for the head of FIG. 3 in a first position;

FIG. 4b shows a patient’s head on the modules for the head of FIG. 3 in a second position;

FIG. 4c shows a patient’s head on the modules for the head of FIG. 3 in a third position;

FIG. 5 shows a mobile unit for storing and transporting the supporting arrangement according to the preferred embodiment of FIG. 1.

### DESCRIPTION OF EMBODIMENTS

The supporting arrangement according to the invention comprises a kit of separate modules for containing, pushing, supporting and unloading different body segments of the patient’s body.

Said modules are adapted to be arranged on an external supporting surface, for example, a mattress, and are freely positionable and orientable with respect to one another on said external supporting surface, besides being freely positionable and orientable with respect to the supporting surface itself.

Each of said modules comprises a rigid or semi-rigid shaped body and a padding.

Said rigid or semi-rigid shaped body may be made as a single piece or may be obtained by superimposing separate layers.

Each module is preferably coated with a waterproof, sanitizable and antibacterial elastic cover, which can provide support and at the same time adapt to the patient.

Advantageously, at least at the bottom and top surfaces, said cover has anti-slip properties, whereby on one part it firmly and securely maintains the position in which it is placed on the supporting structure, and on the other part it prevents the patient from slipping with respect to the proper posture position.

Advantageously, each module is provided with one or more lower levelling elements and/or one or more upper levelling elements, so as to make it apt to support the different morphologies, anatomical structures and anthropometries of the different patients.

Said levelling elements are likewise provided with a waterproof, sanitizable and antibacterial elastic cover. In addition, also in the case of the levelling elements, said cover has anti-slip properties at least at its bottom surface and top surface.

Each module can be provided with a washable, re-usable wrapper or a disposable wrapper, for example made of non-woven fabric.

Under each module there may be provided a rigid or flexible base, to be interposed between the module and the external supporting surface (for example, the mattress).

Said rigid or flexible base can be provided with a cover with anti-slip properties, or with male/female hook-and-loop fasteners, wherein the latter case the module will be provided with corresponding male/female hook-and-loop fasteners for maintaining its position relative to said base.

As an alternative, it is possible to provide for a single common base, either rigid or flexible, to be interposed between the external supporting surface and the kit of modules.

In this case as well, said rigid or flexible common base may be provided with a cover with anti-slip properties or with male/female hook-and-loop fasteners.

Each module, as well as the levelling elements (if any), can be made of a material selected from polymer foams, gels, viscoelastic fluids, air or combinations thereof.

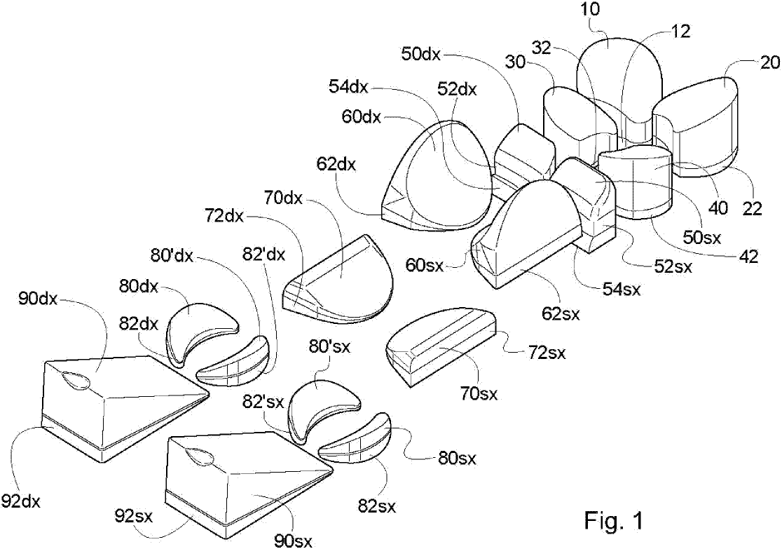

A preferred embodiment of the supporting arrangement according to the invention is illustrated in FIG. 1.

In the embodiment of FIG. 1, the kit of the supporting arrangement according to the invention comprises a pair of modules 50sx, 50dx for the subclavicular area of the patient.

In general, for each body segment the kit will preferably provide for a pair of symmetrical modules, intended to be arranged symmetrically on the opposite sides of the patient’s body. However, this feature must be considered as a preferred and non-limiting feature, and it is also possible to provide that said modules can be arranged asymmetrically if the patient has asymmetries in his/her joints and deformities, so as to always guarantee a perfect adaptation to the patient’s anatomical structure; it is also possible to provide a single module for one or more body segments.

The modules for the subclavicular area 50sx, 50dx are provided with levelling elements 52sx, 52dx, 54sx, 54dx.

In particular, said modules for the subclavicular area 50sx, 50dx are preferably provided with a plurality of levelling elements 52sx, 52dx, 54sx, 54dx, so as to be largely adjustable in height.

This makes it possible to advantageously adapt such modules for the subclavicular area to the body of a female patient by providing for increasing the height of said modules in order to prevent the breast of the patient from being subjected to pressure, or also to adapt them to the chest thickness of a man with a more keeled chest.

The modules for the subclavicular area 50sx, 50dx are also preferably adjustable in height, so as to adapt to the specific morphology of the single user in order to ensure proper expansion of the pectoral muscles during breathing.

In the embodiment of FIG. 1, the kit of the supporting arrangement according to the invention further comprises a pair of modules 62sx, 62dx for the area of the patient’s ribcage 60sx, 60dx, said modules being provided with levelling elements.

Said modules for the area of the patient’s ribcage 60sx, 60dx have a concave surface facing the patient’s body, so as to laterally envelop the ribcage and decompress the abdomen and the torso.

The modules for the area of the ribcage 60sx, 60dx are preferably adjustable in height, width and depth, so as to adapt to the specific morphology of the single user.

In the embodiment of FIG. 1, the kit of the supporting system according to the invention further comprises a pair of modules 70sx, 70dx for the area of the pelvis and hips of the patient, said modules being provided with corresponding levelling elements 72sx, 72dx.

Said modules for the area of the pelvis and hips 70sx, 70dx make it possible to prevent damage to the joints caused by prolonged lying in a prone position.

Said modules for the area of the pelvis and hips 70sx, 70dx are preferably adjustable in height, width and depth, so that they thus ensure different degrees of flexion, which is crucial for obtaining a distributed pronated position.

In the embodiment of FIG. 1, the kit of the supporting arrangement according to the invention further comprises modules 80sx, 80’sx, 80dx, 80’dx for the area of the patient’s knees, said modules being provided with corresponding levelling elements 82sx, 82’sx, 82dx, 82’dx.

For each knee of the patient, there is preferably provided an outer module 80sx, 80dx and an inner module 80’sx, 80’dx, each of them being substantially half-moon-shaped, so as to surround the knee.

Said modules for the knees 80sx, 80’sx, 80dx, 80dx′ are preferably adjustable in height, width and depth, so as to envelop and properly support the knees and thus ensure different degrees of flexion, as well as to prevent overloading of the knees on the mattress, hereby preventing formation of pressure ulcers.

In an alternative embodiment, the kit of the supporting arrangement according to the invention may further comprise modules for the area of the patient’s elbows (not shown in FIG. 1).

Similarly to what has been described above in connection with the modules for the knees, the modules for the elbows will likewise preferably be provided with levelling elements. In addition, in this case as well, for each elbow of the patient there will preferably provided an outer module and an inner module, each being substantially half-moon-shaped, so as to surround the elbow. The modules for the elbows will likewise preferably be adjustable in height, width and depth, so as to envelop and properly support the elbows.

It will be apparent to the person skilled in the art that the fact that the modules for the elbows (like all the other modules of the kit of the supporting arrangement of the invention) are freely positionable on the external supporting surface is particularly advantageous in that the patient can be placed either with his/her arms along his/her sides or with his/her arms at the sides of his/her head and the position of the modules for the elbow can be varied accordingly. It will also be possible to change the position of the patient’s arms over time, while always guaranteeing that the patient’s elbows can be enveloped and supported by the modules of the kit of the supporting arrangement of the invention.

In the embodiment of FIG. 1, the kit of the supporting arrangement according to the invention further comprises a pair of modules for the area of the shins and feet of the patient 90sx, 90dx, said modules being provided with corresponding levelling elements 92sx, 92dx.

Said modules for the shins and feet 90sx, 90dx are preferably adjustable in height and depth (and consequently have an adjustable inclination) to ensure containment and inclined suspension of the legs and feet of the patient.

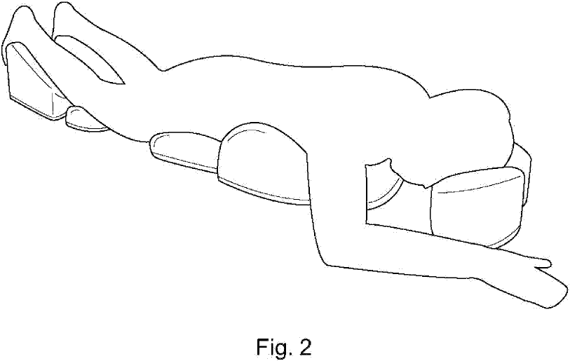

FIG. 2 shows a patient lying in a prone position on the supporting system according to the invention.

It will be evident from FIG. 2 that, thanks to the fact that the modules of the kit of the supporting arrangement according to the invention are freely positionable and orientable with respect to the external supporting arrangement and with respect to one another on said external supporting surface (mattress), and thanks to the fact that they are adjustable in height and/or width, the patient - irrespective of his/her morphology - can remain in pronation even over a long time without suffering collateral damage.

In particular, each body segment of the patient can be supported, unloaded, aligned so as to maintain a proper posture and not to be subjected to detrimental pressures.

As can be seen in FIGS. 1 and 2, the kit of the supporting arrangement according to the invention also advantageously comprises a supporting sub-arrangement for the patient’s head.

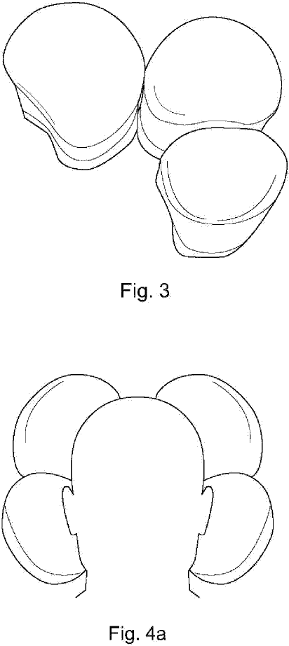

The provision of said sub-arrangement for the head - also shown in greater detail on FIG. 3 - is of fundamental importance because proper support of the head of the patient lying in a prone position and the possibility of orienting the patient’s head in different positions is an extremely complex problem, difficult to solve.

The invention provides a solution to this problem by providing a sub-arrangement consisting of a plurality of separate modules for the head 10, 20, 30, 40 (four in the illustrated embodiment), which are freely positionable and orientable with respect to one another.

Each module for the head 10, 20, 30, 40 is provided with a corresponding levelling element 12, 22, 32, 42.

Each module for the head 10, 20, 30, 40 is preferably adjustable in height and inclination.

Advantageously, the modules for the head 10, 20, 30, 40 are shaped so that, once they are brought close to one another, their top surfaces form together a helix profile.

In particular, each module for the head 10, 20, 30, 40 has an inclined top surface such that they have a trapezoid shape when seen in longitudinal section; in addition, the modules for the head 10, 20, 30, 40 will be provided with different, decreasing heights.

In this way, the modules for the head 10, 20, 30, 40 may be arranged so that, when seen in a clockwise or counterclockwise direction, each module has a smaller height (at the lower side of the inclined top surface) substantially equal to the greater height of the preceding module, and a greater height (at the upper side of the inclined top surface) substantially equal to the smaller height of the subsequent module: thus, it is possible to obtain the helix profile mentioned above.

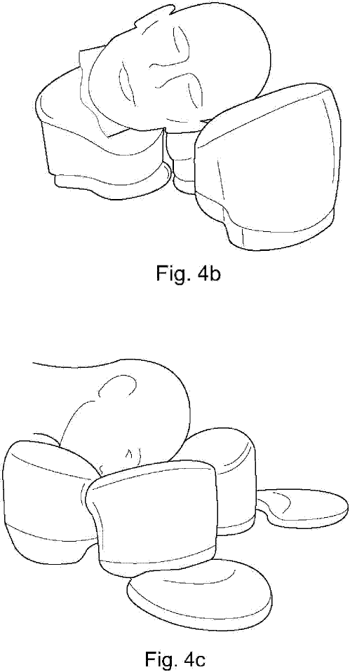

FIGS. 4a - 4c show the positioning of the patient’s head on the modules for the head 10, 20, 30, 40.

As apparent from the Figures, the peculiar configuration of the modules for the head 10, 20, 30, 40 allows the patient’s head to be properly supported in a neutral position (see FIG. 4a), i.e. with his/her gaze downwards, as well as in a position turned to the side (see FIG. 4b). FIG. 4c shows instead how the angle of inclination of the patient’s neck can be adapted by using the removable levelling elements 12, 22, 32, 42.

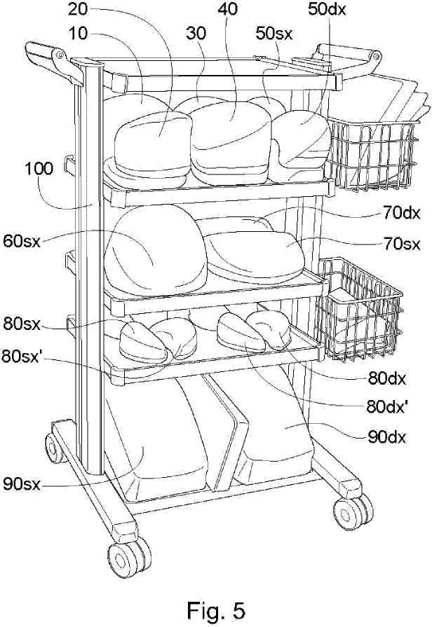

As can be seen in FIG. 5, thanks to the fact that the kit of the supporting arrangement according to the invention consists of separate, independent modules, said modules can easily be placed on a mobile unit 100 having a small size.

This is made possible by the fact that the modules of the supporting arrangement of the invention are not constrained to an external supporting structure (for example, a mattress) on which the patient is placed in a prone position, but they are separated therefrom and can be arranged thereon in a removable manner.

Not only does this feature of the supporting arrangement of the invention allow applying said supporting arrangement to any existing external supporting surface, without the need to modify it, but it also makes it possible, during periods of non-use, to store the modules of said supporting arrangement in a limited space or, as illustrated in FIG. 5, on a mobile unit 100 having a small size.

Said mobile unit 100 can be stored in a storage room and then easily be carried to the place where the patient lies.

In a preferred embodiment of the invention, the modules moduli 10 - 40, 50sx, 50dx -90sx, 90dx for the different body segments may be distinguished by different distinctive elements. For example, they may be made with different colors, or they may bear a distinctive alphanumerical code.

Advantageously, the same distinctive elements may be reproduced on the mobile unit 100, so as to establish a one-to-one relationship between each module 10 - 40, 50sx, 50dx - 90sx, 90dx and the corresponding coded position on said mobile unit. Said one-to-one relationship will enable the operators (even those with little experience) to identify each time the proper module or modules to be applied to each body segment of the patient.

In this connection, in the mobile unit 100 there may be received instruction manuals, coding lists of the distinctive elements of the different modules and other information material.

In particular, in the mobile unit 100 there may be received an instruction manual with the list and explanation of the operations to be carried out in order to properly position the modules of the kit of the supporting arrangement with respect to the patient’s body.

It will be apparent to the person skilled in the art that the supporting arrangement as described and illustrated above makes it possible to achieve the objects set forth above.

It will also be apparent to the person skilled in the art that the embodiment described above has been provided solely by way of example and several modifications and variants within the reach of the person skilled in the art are possible without thereby departing from the scope of the invention as defined by the appended claims.

1. A supporting arrangement for supporting a body of a patient in a prone position, wherein the arrangement comprises a kit of separate modules for containing, pushing, supporting and unloading distinct segments of the patient, wherein the modules are adapted to be arranged on an external supporting surface, wherein the modules are separated from the external supporting surface and are freely positionable and orientable with respect to one another on the external supporting surface.

2. The supporting arrangement according to claim 1, wherein for each segment of the body of the patient one or more pairs of modules are provided the modules of each pair of modules being adapted to be arranged on the opposite sides of the segment of the body of the patient.

3. The supporting arrangement according to claim 1, wherein each of the modules comprises a rigid shaped body, made as a single piece and a padding.

4. The supporting arrangement according to claim 1, wherein each of the modules is provided with a waterproof, sanitizable and antibacterial elastic cover, having a bottom surface and a top surface, and wherein the cover has anti-slip properties at least at the bottom surface.

5. The supporting arrangement according to claim 1, wherein each of the modules is provided with one or more lower levelling elements.

6. The supporting arrangement according to claim 1, wherein each of the modules is provided with a wrapper.

7. The supporting arrangement according to claim 1, wherein each of the modules is provided with a base, suitable for being interposed between the module and the external supporting surface.

8. (canceled)

9. The supporting arrangement according to claim 1, wherein the kit of separate modules comprises at least one of:
one or more modules for the subclavicular area of the patient;
one or more modules for the area of the chest of the patient;
one or more modules for the area of the pelvis and hips of the patient;
one or more modules for the area of the knees of the patient; and
one or more modules for the area of shins and feet of the patient.

10. The supporting arrangement according to claim 1, wherein the kit of separate modules comprises a plurality of separate modules for the head of the patient, freely positionable and orientable with respect to one another.

11. The supporting arrangement according to claim 10, wherein the modules for the head of the patient are shaped so that, their top surfaces form together a helix profile when they are brought close to each other.

12. The supporting arrangement according to claim 11, wherein the modules for the head of the patient have an inclined top surface, a trapezoid shape when seen in longitudinal section, and different heights from one another.

13. The supporting arrangement according to claim 12, wherein the modules for the head of the patient has a smaller height at the lower side of the inclined top surface and a greater height at the upper side of the inclined top surface, and wherein the modules for the head of the patient are arranged so that, when seen in clockwise or counterclockwise direction, the smaller height at the lower side of the inclined top surface of each module for the head of the patient is substantially equal to the greater height at the upper side of the inclined top surface of the preceding module for the head of the patient, and the greater height at the upper side of the inclined top surface, of each module for the head of the patient is substantially equal to the smaller height at the lower side of the inclined top surface of the subsequent module for the head of the patient.

14. The supporting arrangement according to claim 1, wherein the modules are distinguished each by a corresponding distinctive element, such as a color or an alphanumeric code.

15. The supporting arrangement according to claim 1, wherein the arrangement comprises a mobile unit for storing and transporting the modules.

16. The supporting arrangement according to claim 15, wherein the modules are distinguished each by a corresponding distinctive element and the mobile unit has a plurality of coded positions, and wherein there exists a one-to-one relationship between the distinctive element of each module and the corresponding coded position on the mobile unit.

17. The supporting arrangement according to claim 1, wherein each of the modules comprises a rigid shaped body, made as a superposition of a plurality of separate layers, and a padding.

18. The supporting arrangement according to claim 1, wherein each of the modules is provided with a waterproof, sanitizable and antibacterial elastic cover having a bottom surface and a top surface, and wherein the cover is provided with hook-and-loop means at least at the bottom surface.

19. The supporting arrangement according to claim 1, wherein each of the modules is provided with a waterproof, sanitizable and antibacterial elastic cover having a bottom surface and a top surface, and wherein the cover has anti-slip properties at least at the top surface.

20. The supporting arrangement according to claim 1, wherein each of the modules is provided with a waterproof, sanitizable and antibacterial elastic cover having a bottom surface and a top surface, and wherein the cover is provided with hook-and-loop means at least at the bottom surface.

21. The supporting arrangement according to claim 1, wherein each of the modules is provided with one or more upper levelling elements.
